(19) United States
(12) Patent Application Publication
(10) Pub. No.: US 2010/0042950 A1
(43) Pub. Date: Feb. 18, 2010

(54) ELECTRONIC DEVICE EQUIPPED WITH TOUCH SCREEN DISPLAY AND CONTROL METHOD THEREOF

(75) Inventors: KUAN-HONG HSIEH, Tu-Cheng (TW); HAN-CHE WANG, Tu-Cheng (TW); HUA-DONG CHENG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY ShenZhen) CO., LTD., Shenzhen City (CN); HON HAI PRECISION INDUSTRY CO., LTD., Tu-Cheng (TW)

(21) Appl. No.: 12/428,443

(22) Filed: Apr. 22, 2009

(30) Foreign Application Priority Data
Aug. 14, 2008 (CN) 200810303780.1

(51) Int. Cl. G06F 3/048

(52) U.S. Cl. 715/835; 715/863

(57) ABSTRACT

An electronic device equipped with touch screen display and control method thereof is provided. The electronic device includes a memory configured for storing menu information defining one or more menus, and a predetermined number of times of touches, a touch screen display configured for detecting a touch of a user, a counter configured for counting a number of touches on the touch screen display since the last update of the positions of the menu icons on the display, and an processor configured for executing a function corresponding to the content of a menu whose menu icon is touched, and further configured for updating the position information of the menus stored in the memory as well as shifting the display positions of menu icons of the menus on the touch screen display when the number of touches has reached the predetermined number of times.

### BACKGROUND

1. Technical Field

The disclosure relates to an electronic device equipped with a touch screen display, and a control method thereof, particularly to an electronic device and a control method for preventing the surface of the touch screen display from being physically damaged.

2. General Background

Touch screen displays are used as the input and output device for portable information terminals which are widely used in recent years. Compared to other peripheral equipment of computers, the touch screen display is one of the most effective and convenient devices for inputting data. However, menus are typically displayed in the same positions on the touch screen display, which means the same points on the screen will be touched again and again eventually wearing or damaging those points.

Thus, various methods have been proposed to overcome the foregoing drawback, for example, a hard film coating such as a silicone-based compound layer is used for protection of the surface of the touch screen display and prevention of physical damage to the touch screen display such as from abrasion. However, the adoption of the film increases the cost of the touch screen display, and accordingly increases the cost of the portable information terminal equipped with such a touch screen display.

Therefore, it is necessary to provide an electronic device with a touch screen display and control method thereof which can resolve the above-mentioned problem.

### BRIEF DESCRIPTION OF THE DRAWINGS

FIG. 1 is a block diagram showing an electronic device equipped with a touch screen display in accordance with an exemplary embodiment of the present disclosure.

FIG. 2 is a schematic diagram showing two menu icons displayed on a display indicated in FIG. 1.

FIG. 3 is a schematic diagram showing a plurality of menu shift modes stored in a memory indicated in FIG. 1 according to an exemplary embodiment.

FIG. 4 is a flow chart showing a control method of shifting the menu icons displayed on the display indicated in FIG. 1, according to an exemplary embodiment.

### DETAILED DESCRIPTION

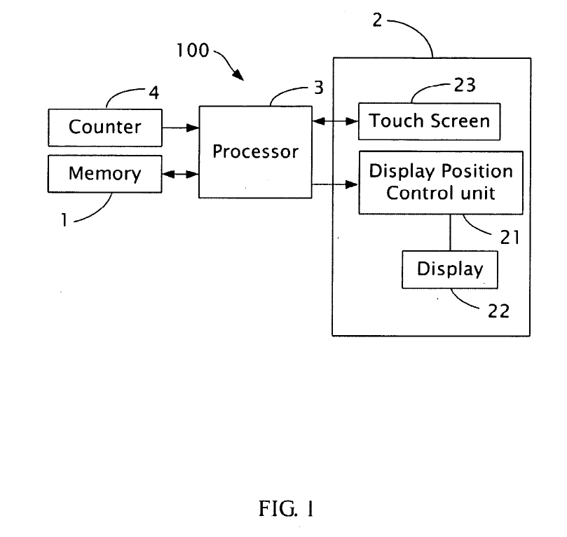

FIG. 1 is a block diagram of an electronic device 100 equipped with a touch screen display 2 in accordance with an exemplary embodiment. The electronic device 100 may be a photo frame, a camera, a portable computer or the like. The electronic device 100 includes a memory 1, a touch screen display 2 including a display position control unit 21, a display 22 and a touch screen 23 which is laid over the display 22, and a processor 3. The display 22 may be a liquid crystal display (LCD), cathode-ray tube (CRT) or the like.

The memory 1 is configured for storing menu information defining one or more menus with their menu icons displayed on the display 22, one or more menu shift modes defining fashions for the shifting of the menu icons, i.e., update display positions on the display 22 and a predetermined number of touches on the touch screen 23. In the exemplary embodiment, the menu information includes position information defining the display positions of the menu icons on the display 22 and contents of the menus interrelated with the display positions of the menu icons. The touch screen 23 is configured for detecting a presence and location of a touch of a user and outputs the location of the touch to the processor 3. The processor 3 is configured for controlling the display control unit 21 to display menu icons on the display 22 according to their display positions, determining whether a menu icon is touched and reading the content of a menu whose menu icon is touched and executing functions corresponding to the content of the menu. Generally, if a touch is located at the display position of a menu icon, the menu icon is considered as “touched” by the users.

The electronic device further includes a counter 4 which is configured for counting an actual number of times the touch screen 23 has been touched since the last update of the display positions of the menu icons on the display 22. The counter 4 counts the actual number of touches based on information provided by the touch screen 23 or by the processor 3, and the counter 4 then provides the actual number touches to the processor 3. When the actual number of touches on the touch screen 23 reaches the predetermined number of touches, the processor 4 selects one of the menu shift modes stored in the memory 1 to shift, i.e., updates the position information of the menu icons stored in the memory 1, and also to update the display positions of the menu icons on the display 22. Then the counter 4 is cleared to zero by the processor 3 and restarts counting the number of touches on the touch screen 23.

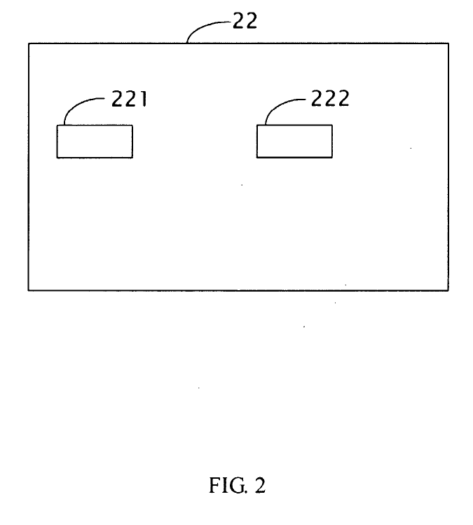

FIG. 2 is a schematic diagram showing the electronic device displaying a plurality of menu icons on the display. In the exemplary embodiment, there are two menu icons 221 and 222. The menu icons 221 and 222 are displayed on the display 22 in accordance with their position information stored in the memory 1. The number of menu icons on the display is not to be construed as being limiting but are merely presented as an example, various changes in the number of menus may be made to the embodiment.

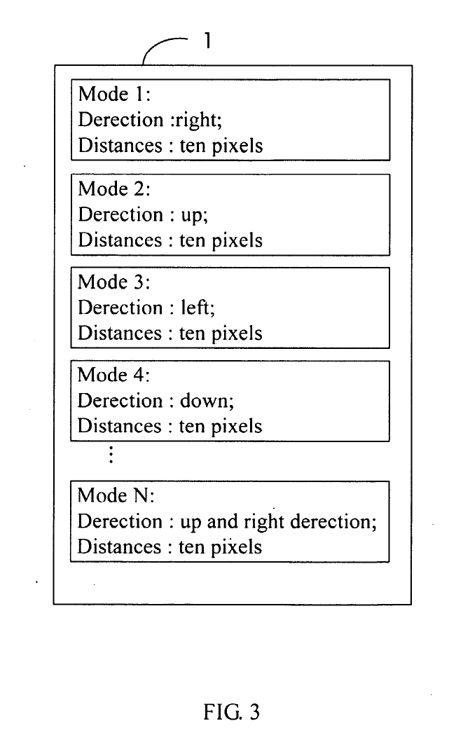

FIG. 3 is a schematic diagram showing a plurality of menu shift modes stored in the memory 1. In the exemplary embodiment, each of the menu shift modes defines a fashion including a shift direction and a shift distance of a menu icon from a previous position to a subsequent position. The first four and the last one menu shift modes are shown as examples. Mode 1 defines a ten pixel shift to the right, mode 2 defines a ten pixel shift up, mode 3 defines a ten pixel shift left, mode 4 defines a ten pixel shift down, and the last mode, mode N, defines a double shift, that is a ten pixel shift up and a ten pixel shift to the right.

Therefore, according to the menu shift mode 1, the processor 3 will update the position information of the menus stored in the memory 1 as well as the display position of the menu icons by shifting the display positions of the menu icons ten pixels to the right. According to the menu shift mode 2, the processor 3 will update the position information of the menus stored in the memory 1 as well as the display positions of the menu icons by shifting the display positions of the menu icons on the display 22 ten pixels to the right. In the same manner or fashion, according to the mode N, the processor 3 will update the position information of the menus stored in the memory 1 as well as the display position of the menu icons by shifting the display position of the menu icons ten pixels to the right and ten pixels up.

In the exemplary embodiment, the shift distance of the menus is given as ten pixels, naturally in other embodiments direction and amount of shift and number of shifts can be determined as desired or according to need.

When the actual number of touches on the touch screen 23 has reached the predetermined number of times, the processor 3 selects a particular or a fixed menu shift mode to shift, i.e., updates the display positions of the menu icons.

In the exemplary embodiment, the selection is made based on a predetermined sequence of the menu shift modes or at random, or according to user requirements.

In the exemplary embodiment, the processor 3 is also configured for preventing any menu icon from being displayed outside of an effective display area of the display 22 when shifting the menu icons.

In the exemplary embodiment, when any menu icon approaches or already reaches a border of the display 22 at the last update of display positions of the menu icons, the processor 3 is capable of selecting a menu shift mode to shift the display position of the menu icon away from the border at the next update.

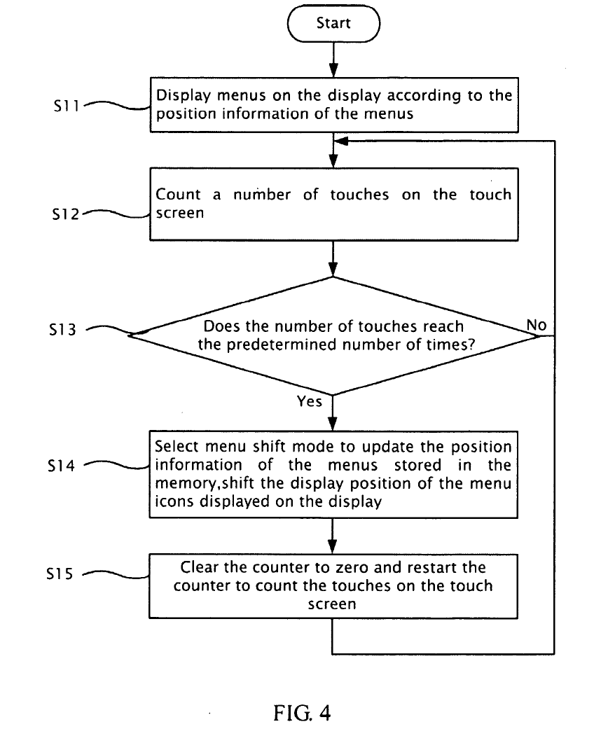

FIG. 4 is a flow chart showing a control method of shifting the menu icons displayed on the display 22, according to an exemplary embodiment. Firstly, in step S11, the processor 3 controls the touch screen display 2 to display menu icons according to the position information of the menus. In step S12 the processor 3 starts the counter 4 to count number of touches on the touch screen 23. In step S13, the processor 3 determines whether the number touches on the touch screen 23 has reached the predetermined number of times. If the number of touches has not reached the predetermined number of times, the procedure repeats step 13. If the number of touches has reached the predetermined number of times, the procedure goes to step 14, in which the processor 3 selects a menu shift mode from the memory 1 to update the position information of the menus stored in the memory, as well as to shift, i.e., update the display positions of the menu icons on the display 22. In step 15, the processor 3 clears the counter 4 to zero and the counter 4 restarts counting the number of touches on the touch screen 23 and the procedure goes back to step 12. The procedure is recycled till the electronic device is shutdown or till some other event occurs, such as the user manually terminates the display of menu icons on the display 22.

When certain menu icons displayed on the display 22 are touched, the processor 3 reads the content of a menu corresponding to the menu icon and executes function corresponding to the content of the menu.

Based on the preferred embodiments disclosed above, an advantage of the present electronic device 100 equipped with a touch screen display 2 over the prior art becomes clear. The advantage is that the electronic device can update the display positions of the plurality of menus displayed on the display according to number of touches on the touch screen 23, thus preventing any one portion of the surface of the touch screen display from being touched more than other areas, thus prolonging the aesthetic and useful life of the screen.

Although the present disclosure has been specifically described on the basis of an exemplary embodiment thereof, the disclosure is not to be construed as being limited thereto. Various changes or modifications may be made to the embodiments without departing from the scope and spirit of the disclosure.

What is claimed is:

1. An electronic device equipped with a touch screen display, comprising:
a memory configured for storing one or more menu information defining one or more menu icons, one or more menu shift modes defining fashions with which the menus are shifted, and a predetermined number of touches on the touch screen display, wherein the menu information further comprises position information defining the display positions of the menu icons on a display and contents of the menus interrelated with the display positions of the menu icons;
a display configured for displaying menu icons of the menus;
a touch screen configured for detecting a presence and location of a touch of a user and outputs the location of the touch;
a counter configured for counting a number of touches on the touch screen since a last update of the display positions of the menu icons, and
a processor configured for selecting a menu shift mode among all the menu shift modes to update position information of the menus stored in the memory, and shifting the display positions of the menu icons on the display when the number of touches on the touch screen has reached the predetermined number of times.

2. The electronic device as claimed in claim 1, wherein each of the menu shift modes define shift directions and shift distances of the menu icons from a previous position to a subsequent position.

3. The electronic device as claimed in claim 1, wherein the processor is also configured for clearing the counter to zero and restarting the counter to count touches on the touch screen after shifting of the display positions of the menu icons.

4. A control method for controlling an electronic device which comprising a touch screen display, comprising:
counting a number of touches on a touch screen of the touch screen display since the last update of display positions of menu icons of menus on a display of the touch screen display; and
updating position information of the menus stored in a memory and shifting the display position of the menu icons on the display when the number of touches has reached the predetermined number of times.

5. The control method as claimed in claim 4, further comprising: clearing the counter to zero, and restarting the counter to count the touches on the touch screen after the updating step.

6. The control method as claimed in claim 5, wherein the updating step further comprising: selecting a menu shift mode which defines shift directions and shift distances of the menu icons on the display and updating position information of the menus and shifting the display position of the menu icons on the display according to the shift direction and the shift distances defined by the menu shift mode.
